(19) United States
(12) Patent Application Publication
(10) Pub. No.: US 2014/0263016 A1
(43) Pub. Date: Sep. 18, 2014

(54) Magnetic Water Particulate Conditioner

(71) Applicant: Harry Jones, Vista, CA (US)

(72) Inventor: Harry Jones, Vista, CA (US)

(21) Appl. No.: 14/217,237

(22) Filed: Mar. 17, 2014

Related U.S. Application Data
(60) Provisional application No. 61/793,909, filed on Mar. 15, 2013.

(51) Int. Cl. C02F 1/48

(52) U.S. Cl. CPC C02F 1/48; C02F 1/481; C02F 1/484
USPC 210/222

(57) ABSTRACT

A water conditioner device is provided with magnets engaged on opposing sides of a gap and engaged to a housing. Projections extend from said housing in opposite directions and are aligned with said gap and each other. These projections are engageable with a compressive engagement of the projections with a water pipe to treat water running therethrough.

This application claims priority to U.S. provisional patent application Ser. No. 61/793,909 filed on Mar. 15, 2013 and incorporated in its entirety by this reference.

### BACKGROUND OF THE INVENTION

1. Field of the Invention

The present invention relates to a conditioner for a pipe-delivered water supply. More particularly, it relates to magnetic conditioner engageable in alignment with a water pipe in a fashion where opposing magnetic flux provides the magnetic field which functions as an ionic accelerator to inhibit the formation of mineral scale deposits and encrustation upon downstream plumbing components and fixtures.

2. Prior Art

Magnetic water treatment or conditioning is modernly employed for reducing the effects of hard water which is heavy with particulate and dissolved solid minerals, by passing it through a magnetic field. Such treatments are favored by many home and industrial users as it is a non-chemical alternative to water softeners which use expensive filters or salt or other chemicals.

While not actually filtering the scale and deposit-causing minerals from the water supply, the employment of such magnetic treating components, when properly engaged, with the incoming water supply, is known to have a significant effect on the downstream water scale and deposits in water heaters, on water fixtures and faucets and bathtubs and showers.

The magnetic treatment of water and fluids generally are known to cause certain physical and physicochemical changes to the water or fluid due to a restructure and reduction in size of the molecular clusters. In particular, water that has been subjected to magnetic fields will exhibit certain properties including: reduced viscosity, an increase in dissolveability, increased oxygen content, increased conductivity and increased permeability of treated water in respect to soil and plant capillaries and pores.

Residential and commercial water treatment devices employing magnetic field components, expose the incoming water to a magnetic field. This is modernly accomplished using permanent magnets or electromagnets of varying construction.

However, the prior art systems have employed engagements of the magnetic field generating components, to the water pipes, which are hard to install and are not configured to insure that the orientations of magnets providing the flux and field, are parallel and properly spaced and not subjected to interference from the housing supporting the magnets. This results in angular engagements to the axis of water pipes, and reduced or redirected flux fields from direct contact of the field generating magnets with conductive magnetic housings which themselves become magnetized by such contact.

As a result of this improper mounting, the fluid flow through the engaged magnetic components, is not subjected properly or at appropriate angles to the flux field to treat the water with the full effects of the magnetic field generated by the magnets. While prior art has attempted to cure these ill engaged components with ever stronger magnets, the continued resulting angular engagement caused by tight installation confines or ill-trained personnel, as well as the magnification of the housings placed in contact with the magnets, has rendered such attempted remedies ineffective.

Magnetic conditioners when properly placed along water pipes subject the water to the magnetic fields of the parallel magnets which act as an ionic accelerator which causes the dissolved minerals in the water to maintain a separation and minimizes interaction with surfaces thereby impeding the deposit of scale from the mineral substances transported by the water. Effective conditioners employ two opposing permanent magnets adjacent the water pipe and positioned for opposing polarity. It is most important that the magnets remain properly spaced in their housing relative to the pipe, and parallel to the axis of the pipe to enhance the travel distance of the magnetic field or flux therethrough.

Additionally, the axis of the elongated opposing magnets should be parallel to each other, as well as to the axis of the water pipe running therethrough to additionally maximize the exposure of the generated magnetic field to the flowing water. However, as noted, many housings are formed of steel or iron or materials which become magnetized if contacted by the magnet, and thereby severely inhibit and deflect the projected field from the opposing magnets, from an optimum strength and path.

It is frequently a housing construction which provides this magnet mount, and resulting means for engagement of the housing to water pipes, which causes this mal-alignment and magnetic field divergence. Further, in the tight confines where such magnetic conditioners are installed, the strong fields and magnetic attraction of metal mounts can render it hard or almost impossible to align the magnet axis of the opposing magnets with the axis of the pipe between them and therefor the axis of the flowing water.

As such, there is a continuing unmet need for an improved magnetic water conditioner. Such a device should provide opposing magnets which are engaged with a mount or housing, which maintains the two magnets parallel, and evenly spaced from the pipe, and which have their respective axis substantially aligned with the axis of the pipe being treated. Such a device should be easy to install on or over the pipe being treated. Such a device should provide a means keeping the magnets parallel to each other and having an concurrently having a passage with an axis substantially aligned to that of the pipe during and after mounting to the pipe.

### SUMMARY OF THE INVENTION

The magnetic water conditioner device and method herein, employs at least two opposing permanent magnets engaged with a single fixed space housing or mount in one preferred mode. In another it employs a plurality of mounting components configured to engage each other and the pipe. In all modes the device herein is adapted to maintain the respective axis of the magnets as well as that of the pipe, aligned.

The housing so engaged, positions the two substantially equally sized and strength magnets, contiguous to the water pipe. It maintains both magnets out of magnetic contact with the water pipe, and spaced therefrom by a nonconductive material or preferably metal such as stainless steal, so as to create magnetic field lines which intersect with opposing poles along the axis of the pipe in the direction of the water flow in the pipe, and the pipe axis. The magnets currently employed are parallel but with poles reversed to develop a flux or magnetic field north and south reaction within the water flowing in the pipe.

A novel mounting system insures the alignment of the magnets with the pipe axis, even when installed by inexperienced personnel or in tight confines where conventional magnetic conditioners are engaged crooked and improperly. The mounting system employs a strip of non magnetic material such as stainless steel. The stainless steel member acts to space the wall of the housing from magnetic contact with the pipe. This spaces the housing wall from the pipe, with a non magnetic material such as stainless steel, from the contact with the pipe with the strip being aligned with the pipe.

Further, the elongated strip preferably extends a distance beyond the housing at a centered position on both sides of the assembled housing at positions substantially aligned with the axis of the pipe. Mounting of the housing to the pipe is accomplished by means for compressive engagement of the opposing projecting tabs to the pipe, such as a hose clamp or a plastic tie wrap.

As a result of this tabbed engagement to the pipe along its axis, the housing and the respective axis of both magnets are aligned with the axis of the pipe. Further, the installer need not measure or worry about proper installation for maximum efficiency, nor can an inexperienced installer incorrectly align the housing and magnets.

So engaged with the tabs, and with the non magnetic conducting metal separator maintaining the pipe in an equidistant spacing from the housing along its axis, the flux generated by both parallel equally spaced magnets is communicated though the water in the pipe in a manner to maximize the collision of the north and south flux for the water treatment. To protect the housing and magnets from corrosion, the housing and magnets are plastic or powder coated with a polymeric or plastic insulating material such as polyester or PVC or an other powder coating or spray coating.

With respect to the above description, before explaining at least one preferred embodiment of the magnetic water treatment device herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed magnetic water treatment device and method. It is important, therefore, that the claims be regarded as including such equivalent construction and methodology insofar as they do not depart from the spirit and scope of the present invention.

It is an object of the invention to provide a magnetic water treatment device which mounts in a fashion to maximize communication of the magnetic field with the water or fluid inside a pipe.

### BRIEF DESCRIPTION OF DRAWING FIGURES

FIG. 1 shows a particularly preferred mode of the device with two elongated magnets mounted to a U-shaped first member which is configured for registered engagement with a planar member.

FIG. 2 depicts an end view of the device of FIG. 1 and typical of the engagements of the opposing tabs on all embodiments herein.

FIG. 3 depicts a mode of the housing having two “L” shaped housing components which engaged in a registered engagement with each other and aligned with the pipe using alignment mounting tabs.

FIG. 4 shows an end view and engagement of the device of FIG. 3, showing the mounting tabs aligning the housing with the axis of the water pipe spaced from the pipe and held by a tie wrap or other means of engagement appropriate thereto.

FIG. 5 shows a slice through FIG. 5, showing the magnetic material forming the two magnets and the non conductive material forming the strip centered in the housing and parallel to the pipe and extending to form the tabs.

FIG. 6 depicts a typical side view of all modes of the device showing the tabs aligned with the pipe and engaged by tie wraps.

FIG. 7 is a typical top or bottom view of all modes of the device engaged to the pipe and aligned therewith by extending tabs.

FIG. 8 is another perspective view of the mode of the device of FIG. 3.

FIG. 9 shows a perspective top view of the device engaged with a pipe in typical fashion for all modes.

FIG. 10 shows a particularly preferred mode of the device where the tabs extend from the casing wall, in a curve matching the exterior curve of the water pipe and providing a self centering mount.

FIG. 11 shows a top view of the device of FIG. 10 in a centered engagement with a water pipe.

FIG. 12 depicts the device engaged upon a planar stainless steel or other non magnetic material forming the housing and projecting mounting tabs.

FIG. 13 depicts the device of FIG. 12 being engaged over a pipe.

FIG. 14 depicts a mode of the device having a planar housing and having a planar non magnetic member extending along the axis between the two magnets and forming the mounting tabs.

### DETAILED DESCRIPTION OF THE PREFERRED EMBODIMENTS OF THE INVENTION

Now referring to drawings in FIGS. 1-14, wherein similar components are identified by like reference numerals, there is seen in FIG. 1 a particularly preferred mode of the device 10 for magnetic water conditioning. In this mode, the housing 14 shown assembled in FIG. 2, includes a U-shape member 16 and a planar member 18 configured to mate with the U-shaped member 16 to form the housing 14 shown in FIG. 2.

This mode is a favorite because it works especially well where the pipe 20 is positioned in tight confines, such as adjacent to a block or other wall on one side. In such an installation, the 18 to 20 gauge thickness of the planar member 18, will easily slip between a wall and the pipe 20 to allow subsequent secure engagement of the housing 14 formed in this mode by the U-shaped member 16 thereto.

Tabs 22 or projections extending from the housing 14 center centered over a gap 24 between magnets 26 engaged with the U-shaped member 16 and also tabs 22 on the planar member 18 are positioned such that they align with the center axis of the pipe 20, and each other. The tabs 22 are also positioned to place the pipe into the gap 24 in between the opposing magnets 26 with its exterior circumfrenced equidistant therefrom with the axis of the pipe 20 centered between the respective axis of the magnets 26 and within the gap 24. The projections formed by the tabs 22 may be planar on the side contacting the pipe 20 or as in FIG. 3, they may have a curve 15.

Currently ceramic magnets 26 having a cross sectional area equal to or larger than that of the pipe 20 are the favored magnet however this size may alter with different magnets such as rare earth magnets which have stronger magnetic flux. Securement using a compressive encircling means for engagement such as a hose clamp, or zip tie 28 around the tabs 22 and the pipe 20 will hold both components forming the housing 14 in registered engagement, and maintain the positioning of the axis of the pipe 20 substantially equidistant from the axis of both respective magnets 26 when in the gap 24.

In all modes of the device 10 herein, the projections provided by the tabs 22 makes it easy for untrained personnel to position the device 10 perfectly every time, since the tabs 22 are positioned on both the planar member 18 if employed, and the member holding the magnets in all modes, to mate the components and magnets in a registered positioning to mount and/or form the housing 14. Concurrently the projections provided by the tabs 22 allow for a stable securement to the pipe 20 in the aforementioned proper positioning for maximum exposure to both the magnetic fields. Further, if employed, using the tabs 22 on the planar member 18 allows for securement even to pipes placed adjacent to walls since they can either be pried slightly away from the wall, or as is usual, are already just slightly away from the wall due to their supportive mounts.

In some modes of the device 10 herein, it is preferable to coat or paint, or film cover, or otherwise adhere a dialectic layer to the exterior of the planar member 18, the U-shaped member 16, and the magnets 26, to prevent corrosion, and to maintain the magnets 26 out of a direct magnetic contact with the pipe 20 which could impair the magnetic field projection.

Additionally preferred is the employment of a non magnetic metal such as stainless steel, for the support member 30 which is positioned to communicate across both the U-shaped member 16 and the planar member 18, in a position to align with the axis of the pipe 20 when the device 10 is engaged. This provides a separation of the pipe 20 from the metal forming the two components of the housing 14, and forms the tabs 22 in the correct position.

It has been found through experimentation that using stainless steel for the support member 30, which is not magnetically attractive, but still a metal, helps focus the magnetic field through the liquid in the pipe 20 running along the gap 24 and such is a preferred construction of the tabs 22 with the support member 30 in all modes of the device shown and described herein.

Thus the use of stainless steel, a metal, but a non magnetic material as magnetic separator between the metal of the casing 14 unless it too is stainless, has been found to help concentrate any stray flux longitudinally oriented, toward and into the pipe from the opposing north and south poles to better penetrate the fluid flow path and increase the communication of the field with the water. Thus the magnetic field effectively communicated to the water stream, reduces the surface charge on small particles of minerals, and changes the shapes of minerals in the water such as solute lime molecules which are modified by the strong magnetic north and south fields. This results in the particles in the water which normally would form scale, to precipitate as spherical or round crystals increasing their tendency for them to coagulate as large particles which better stay with the flow rather than depositing as scale. The enhanced communication of the magnetic field provided by the stainless steel support enhances this action.

FIG. 2 depicts and end view of the device 10 of FIG. 1 and is a typical side view of the projections provided by the tabs 22 in an aligned engagement with the pipe 20 thereby positioning the axis of the pipe 20 equidistant from the respective parallel axis of the magnets 26 as well as their side surfaces. As can be seen, a tightening of the zip tie 28 to compress the tabs 22 against the pipe 20 also holds the planar member 18 to the U-shaped member 16 and secures all components to the pipe 20.

FIG. 3 depicts a mode of the device 10 having housing 32 having two “L” shaped member 34 components which engage in a registered engagement with each other and align with the pipe 20 using alignment from the projections provided by the mounting tabs 22 and the compressive engagement provided by the zip tie 22 or another means for compressive engagement such as a hose clamp or circular clamp to the pipe 20.

FIG. 4 shows and end view and engagement of the device 10 of FIG. 3, showing the mounting and alignment tabs 22 aligning the housing 32 with the water pipe 20 centered in the gap 24 and equidistant from the respective parallel axis of the magnets 26.

FIG. 5 shows a slice through FIG. 4, showing the magnetic material forming the two magnets 26 and the non conductive material, such as stainless steel, forming support member 30 which extends from both housing components to form the tabs 22. The tabs 22 in all modes are engaged to their respective housing component aligned to maintain the two halves of the housing in registered engagement with each other if two are employed, and to place the pipe 20 with its axis centered in the gap 24 between the parallel respective axis of the magnets 26 to maximize the communication of the magnetic flux through the pipe 20 and the water therein, to maintain the minerals in the water in a state where the will not adhere or form grime when the water dries on plumbing.

FIG. 6 depicts a typical side view of the device 10 formed by two components which form the casing, engaged to a water pipe 20. As can be seen, the projections forming the tabs 22 are positioned to hold the device 10 to the pipe 20, and to register that engagement such that the pipe axis is centered in the gap 24 and between both parallel axis of the magnets. Also shown are the novel tab 22 engagement projections allowing for an automatic registered engagement of both housing components, and the device 10 with the pipe 20.

FIG. 7 is a typical top or bottom view of all modes of the device 10 engaged to the pipe 20 and in substantially perfect alignment therewith, due to the projecting tabs 22, being positioned to align the device 10 with the pipe axis 21 centered in a gap 24 and in between the parallel axis of both magnets 26. Mounting with the means for compressive encirclement such as the zip tie 28 or a hose clamp, or other ring with tightening adjustment.

FIG. 8 is another perspective view of the mode of the device 10 similar to that of FIG. 3, however with a smaller pipe 20 diameter. For a smaller pipe 20 the gap (FIG. 9) is adjusted in diameter to place the smaller diameter magnets 26 immediately adjacent in a spaced positioning which aligns the axis of the magnets 26 with the axis 21 of the pipe 20 when the zip tie 28 or other compressive ring or loop engagement component, is tightened around the tab 22 positioned on opposite sides of the pipe 20.

FIG. 9 shows a perspective top view of the device 10 of FIG. 8, with the housing 24 assembled and the pipe 20 centered in the elongated gap 24 in a registered engagement with a pipe 20 in typical fashion for all modes.

FIG. 10 shows a particularly preferred mode of the device 10 which has been found after experimentation, to enhance both the engagement to the pipe 20 and the alignment of the magnetic axis of both magnets 26 with the axis 21 of the pipe 20. In this mode, the projections defining tabs 22 extending from positions on both halves of the housing 34 to yield the registered centered positioning of the pipe 20 in the gap 24 and in-between the magnets 26, have a curved bottom surface 23 with matches the curve of the exterior circumference of the pipe 20. This curved surface 23 yields increased contact of the tabs 22 with the pipe 20, and, has a recessed center point at the middle of the curve, which acts to saddle the tab 22 upon the exterior of the pipe 20 and increases the contact surface area.

Tightening the zip ties 28 or hose clamps or compressive rings, causes the pipe 20 adjacent to the tabs 22 on both ends of both halves of the housing 34, to descend into the recess between the ends of the curved bottom surface of the tab 22, and self-center the device 10 on the pipe 20 on both sides of the pipe 20 and both ends of the device 10. This results in an engagement which is perfectly centered, and, will not slide in a direction traverse to the axis 21 of the pipe 20 if for some reason the device 10 is impacted from a side. The curved bottom surface 23 may be employed on any of the modes of the device herein shown and described as an optional enhancement to the already secure tab 22 on pipe 20 engagement.

FIG. 11 shows a top view of the device of FIG. 10 in a centered engagement with a water pipe 20 and the axis 21 of the pipe 20 centered in the gap 24 and between the axis of both magnets and the gap 24. The circumference of the exterior of the pipe 20 is shown engaged within the curved or recessed area of the tabs 22 in an especially secure and self-aligning engagement noted.

FIG. 12 depicts the device 10 with a single component housing 14 of a planar stainless steel or other non magnetic material forming the housing 14, and projecting mounting tabs 22, in a unitary structure. The opposing pole elongated magnets 26 are on opposing sides of a formed gap 24 between them.

FIG. 13 depicts the device of FIG. 12 being engaged over a pipe which is placed within the gap 24 and aligned with the tabs 22 centered along the axis of the pipe during mounting.

FIG. 14 depicts a mode of the device 10 having a planar housing 14 an having a planar non magnetic member 27 engaged to the housing 14 and extending along the axis of the gap 24 between the two magnets 26 and forming the mounting tabs 22.

This achieves an easy but secure mount of the device 10 to the pipe 20 in a registered engagement of the device 10 to the pipe 20 which positions the axis of the magnets 26 parallel to, and equidistant from, the axis of the pipe 20. This positioning, insures maximum communication of the flux or magnetic fields of the magnets 26 through the water moving in the pipe 20 within the gap 24.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A water conditioner apparatus, comprising:
a housing having a first magnet engaged thereto and a second magnet engaged thereto and separated by a gap therebetween;
projections extending from said housing, said projections extending in opposite directions and aligned with said gap and each other;
said projections engageable with a compressive engagement of said projections with said water pipe; and
whereby said water conditioner is removably positionable with said pipe in said gap by connection of said projections thereto.

2. The water conditioner of claim 1 additionally comprising:
a support member engaged with a side of said housing facing said gap;
said support member being formed of stainless steel and having an axis;
opposing portions of said support member projecting past opposing sides of said housing aligned with said gap, thereby forming said projections for engagement to a pipe; and
engagement of said projections with said pipe, aligning said support member with said pipe and centering said pipe in said gap.

3. The water conditioner of claim 2 additionally comprising:
lower surfaces of said support members having a curve;
said curved lower surface matching a curve of an exterior of said pipe.

4. The water conditioner of claim 3 additionally comprising:
a planar cover, said planar cover having a pair of lower projections extending therefrom;
said lower pair of projections being aligned with said opposing portions of said support member;
engagement of said lower pair of projections and said planar cover, to a pipe positioning said pipe in said gap equidistant from both said magnets therein.
